(19) United States
(12) Patent Application Publication
(10) Pub. No.: US 2007/0077793 A1
(43) Pub. Date: Apr. 5, 2007

(54) Detachable pedestal

(75) Inventor: Edward Ko, Tao Yuan Shien (TW)

Correspondence Address: QUINTERO LAW OFFICE, PC, 2210 MAIN STREET, SUITE 200, SANTA MONICA, CA, 90405, US

(73) Assignee: TECHVIEW INTERNATIONAL TECHNOLOGY INC., TAO YUAN SHIEN (TW)

(21) Appl. No.: 11/520,185

(22) Filed: Sep. 12, 2006

(30) Foreign Application Priority Data
Sep. 30, 2005 (TW) TW94134206

(51) Int. Cl. H01R 13/648

(52) U.S. Cl. 439/101

(57) ABSTRACT

A detachable pedestal. The detachable pedestal comprises a base and a support. One end of the base is a first connecting end. The first connecting end comprises a first connecting portion and a first guide portion. One end of the base is a second connecting end. The second connecting end comprises a second connecting portion, a second guide portion and a space. The first guide portion connects to the second guide portion. The first connecting portion passes through the second connecting portion to the space for fixing the base and the support.

### BACKGROUND

The invention relates to a detachable pedestal.

A pedestal is applied to support a display. When packaging a display, a detachable pedestal reduces the volume of the display.

A conventional pedestal comprises a support and a base. The support is fixed to the base via a screw. Turning the screw to fix the support and base is very inconvenient. Before leaving a factory, displays have to be assembled and tested. Thus, if the support and base cannot be rapidly assembled and disassembled, production time is increased.

### SUMMARY

The invention provides a detachable pedestal. The detachable pedestal comprises a base and a support. One end of the base is a first connecting end. The first connecting end comprises a first connecting portion and a first guide portion. The second connecting end comprises a second connecting portion, a second guide portion and a space. The first guide portion connects to the second guide portion. When the first connecting portion passes through the second connecting portion to the space, the support is fixed to the base.

The second engaging portion comprises two flexible portions oppositely installed on the second engaging portion. When the flexible portions are not connected to the first engaging portion, the flexible portions have a first interval therebetween. When the flexible portions are connected to the first engaging portion, the flexible portions have a second interval therebetween. The first interval is greater than the second interval.

The first engaging portion comprises two protrusions oppositely installed thereon. The protrusions have a third interval therebetween. The third interval is less than the first interval.

The first guide portion comprises a protrusion, and the second guide portion comprises a groove. The first guide portion slides in the second guide portion.

The base further comprises a hole exposing the second engaging portion so that force may be exerted thereon for separating the support from the base.

### BRIEF DESCRIPTION OF THE DRAWINGS

The invention can be more fully understood by reading the subsequent detailed description in conjunction with the examples and references made to the accompanying drawings, wherein:

FIG. 1 is an exploded drawing of a detachable pedestal of the invention;

FIGS. 2A-2C are continuous drawings showing an assembled pedestal;

FIG. 3 is an upward view of a detachable pedestal of the invention;

FIG. 4 is a vertical view of a detachable pedestal of the invention;

FIG. 5 is a cross-sectional view along line 5-5 of FIG. 2B.

### DETAILED DESCRIPTION

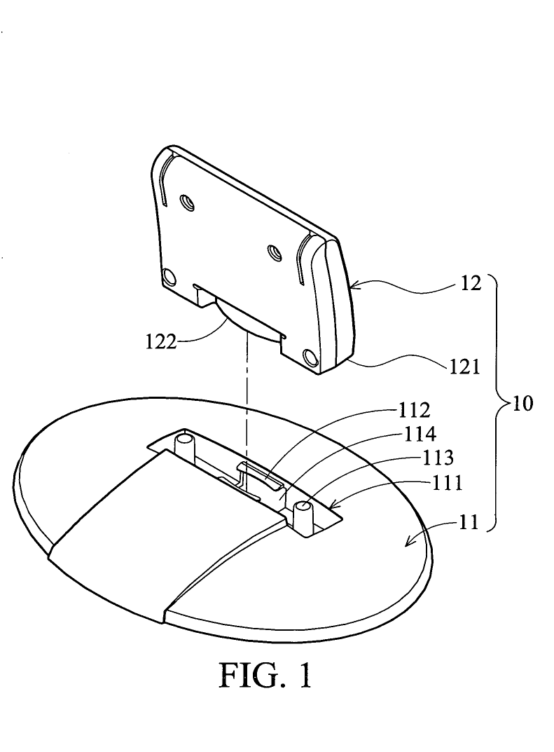

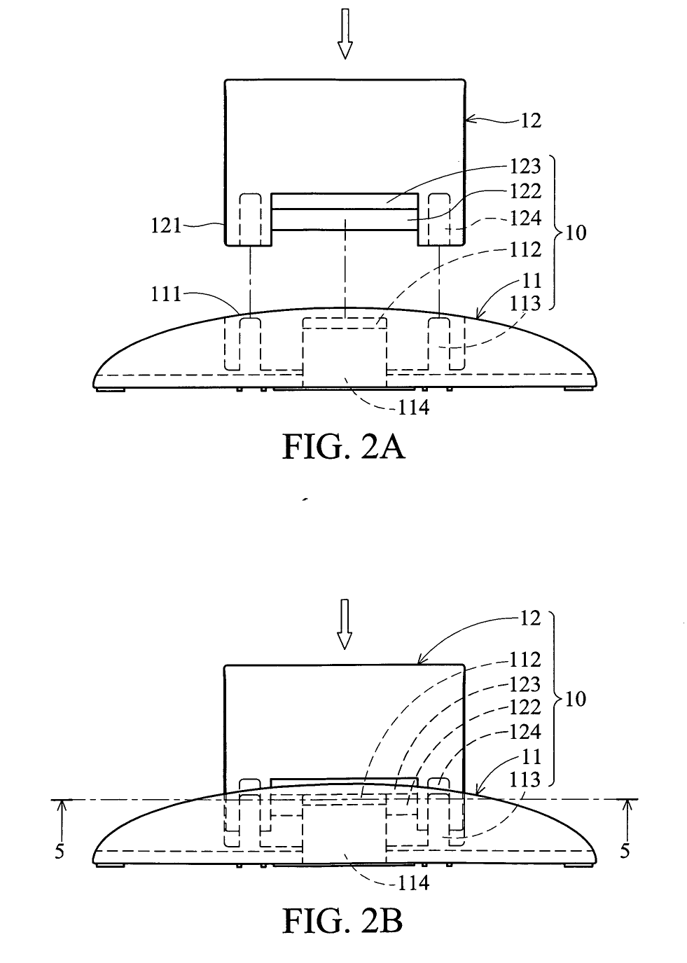

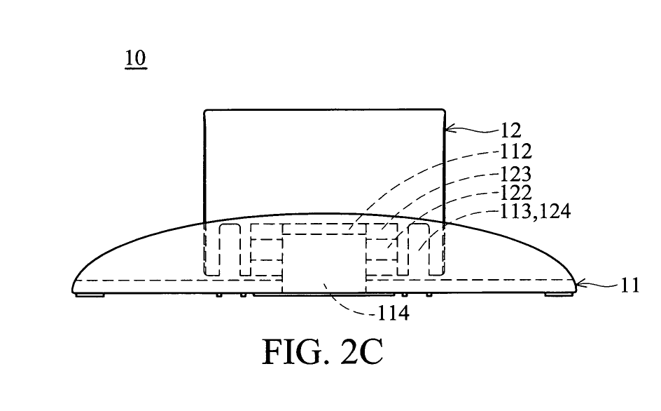

Referring to FIG. 1 and 2A, a detachable pedestal 10 comprises a base 11 and a support 12. The support 12 can be installed on the base 11 and dismantled from the base 11. A first connecting end 111 is installed on the base 11 and comprises two first engaging portions 112 and a first guide portion 113. In this embodiment, the first connecting end 111 is a groove. The first engaging portions 112 are protrusions and oppositely installed in the first connecting end 111. The support 12 comprises a second connecting end 121. The second connecting end 121 comprises two second engaging portions 122, a space 123 (shown by FIG. 2A) and a second guide portion 124. In this embodiment, the second engaging portions 122 oppositely installed on the second connecting end 121 are flexible and curved to the outside of the second connecting end 121. Particularly, a first interval D₁ is located between the second engaging portions 122 (two flexible members) of the support 12 (shown by FIG. 3). FIG. 3 discloses that the second engaging portions 122 are not forced from an external force.

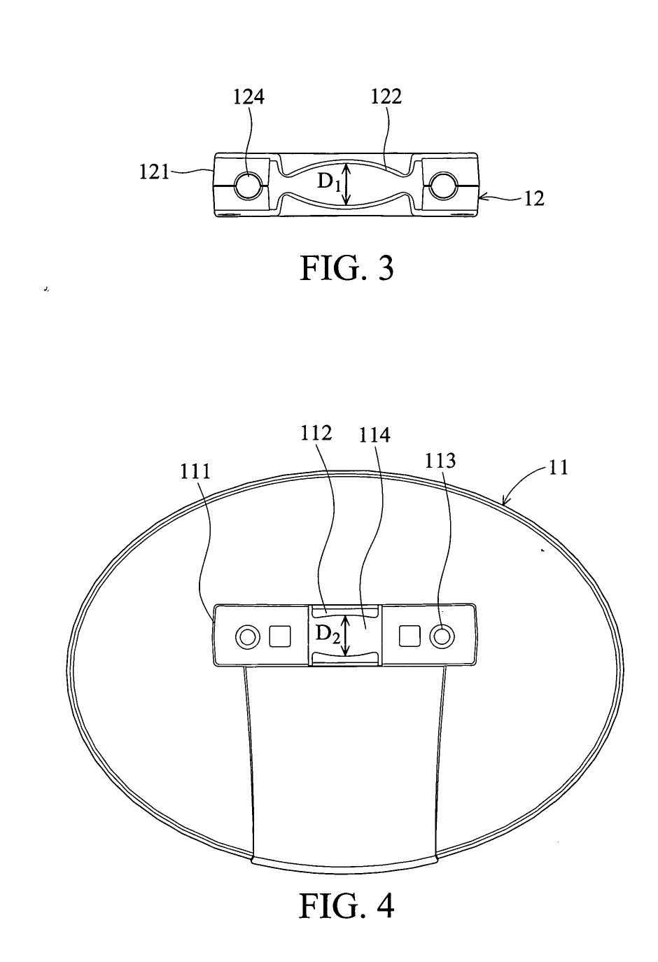

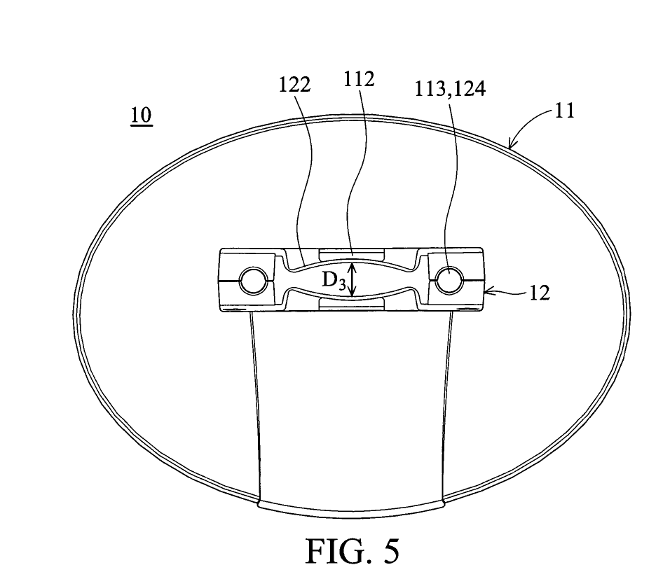

Referring to FIG. 2B, when the support 12 is connected to the base 11, the first guide portion 113 (protrusion) is inserted in the second guide portion 124 (hole) to allow the first guide portion 113 to slide along the second guide portion 124. The second engaging portions 122 are flexible. A second interval D₂ (shown by FIG. 4) between the first engaging portions 112(two protrusions) is less than the first interval D₁ . When the first engaging portions 112 pass outside of the second engaging portions 122, the first engaging portions 112 compress the second engaging portions 122. Thus, the first interval D₁ decreases to form a third interval D₃ (shown by FIG. 5).

Referring to FIG. 2C, the first engaging portions 112 pass by the second engaging portions 122 to the space 123. When the first engaging portions 112 arrive in the space 123, the first engaging portions 112 do not press the second engaging portions 122. Thus, the second engaging portions 122 recover to have the first interval D₁ which are not forced from an external force. Furthermore, the first engaging portions 112 are engaged in the space 123 to provide the support 12 to connect to the base 11.

Referring to FIGS. 1 and 2C, a hole 114 is installed on the inner wall of the first connecting end 111 (groove). To separate the base 11 and the support 12, a user presses the second engaging portions 112 via the hole 114 to reduce the size of the first interval D₁ of the second engaging portions (two flexible member) 122 to less than the second interval D₂ of the first engaging portions (two protrusions) 112. After reducing the first interval D₁ of the second engaging portions (two flexible member) 122 to less than the second interval D₂ of the first engaging portions (two protrusions) 112, a user can separate the support 12 from the base.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A detachable pedestal, comprising:
a base comprising:
a first connecting end comprising:
a first engaging portion; and
a support comprising:
a second connecting end comprising:
a second engaging portion, and
a space,
wherein when the first engaging portion passes through the second engaging portion to the space, the support is fixed on the base.

2. The detachable pedestal as claimed in claim 1, wherein the first connecting end further comprises a first guide portion, and the support further comprising a second guide portion, wherein the support is guided then connected to the base via the first and second guide portion.

3. The detachable pedestal as claimed in claim 1, wherein the second engaging portion comprises two flexible portions oppositely installed on the second engaging portion, wherein when the flexible portions do not connect to the first engaging portion, the flexible portions have a first interval therebetween, when the flexible portions connect to the first engaging portion, the flexible portions have a second interval therebetween, wherein the first interval is greater than the second interval.

4. The detachable pedestal as claimed in claim 1, wherein the first engaging portion comprises two protrusions oppositely installed on first engaging portion, wherein the protrusions have a third interval therebetween, wherein the third interval is less than the first interval.

5. The detachable pedestal as claimed in claim 1, wherein the first guide portion comprises a protrusion, and the second guide portion comprises a groove, wherein the first guide portion is connected in the second guide portion movably.

6. The detachable pedestal as claimed in claim 1, wherein the base further comprises a hole exposing the second engaging portion to a press for separating the base and the support.
